(19) United States
(12) Patent Application Publication
(10) Pub. No.: US 2012/0142854 A1
(43) Pub. Date: Jun. 7, 2012

(54) Poly(Lactic Acid) Shrink Film

(75) Inventors: Matthew Vincent Brandon, Lewisville, NC (US); Yosuke Natsume, Greensboro, NC (US)

(73) Assignee: Bonset America Corporation, Brown Summit, NC (US)

(21) Appl. No.: 12/962,349

(22) Filed: Dec. 7, 2010

(51) Int. Cl. C08G 63/08

(52) U.S. Cl. 524/599

(57) ABSTRACT

Heat shrinkable films based on poly(lactic acid) are disclosed. These PLA films are not only biodegradable and/or compostable, but they can have a combination of properties that make them particularly suitable for use as sleeve labels.

### FIELD OF THE INVENTION

This invention generally relates to heat shrinkable film and, in particular, to poly(lactic acid) heat shrinkable film.

### BACKGROUND OF THE INVENTION

Heat shrinkable films have been widely used for shrink sleeve labels and tamper evidence seals. Heat shrinkable films have mostly been made from polyester, polyvinyl chloride, and poly(styrene-butadiene-styrene). These materials, however, are typically oil-based plastic materials that are made from non-renewable resources.

To make heat shrinkable film more environmentally friendly, poly(lactic acid) or PLA has been used for heat shrinkable film.

The benefits of using PLA for heat shrinkable film are its availability in mass-production scale, compostability, and clarity. However, PLA itself does not have sufficient toughness to be used as a film for heat shrinkable sleeve label.

The typical process for preparing heat shrinkable sleeve label is as follows:

(i) printing images with ink on heat shrinkable film;

(ii) seaming to make printed film into a tube form;

(iii) cutting to each individual sleeve label;

(iv) applying a sleeve label to a container; and

(v) heating to make the sleeve shrink to fit to the container.

During the typical process, the heat shrinkable film is exposed to several mechanical stresses and in order for the film to withstand such stresses, the heat shrinkable film should exhibit sufficient toughness, which is the property usually represented by impact strength and elongation. If a film does not have sufficient toughness, the film may break during the process and reduce process efficiency and yield and could even damage the equipment used for the process.

Also, heat shrinkable film should have high clarity as the image of the label is usually printed on the backside of a label and consumers see the printed image through the film.

Attempts have been made to improve the toughness of PLA heat shrinkable film. These efforts may be classified into three categories: (i) mixing different kinds of biodegradable plastics with PLA (e.g., JP9169896A, JP2002234117A, and JP2004002776A); (ii) adding certain additives such as plasticizers (e.g., JP9151310A, US20090074999, and US20070116909A1); and (iii) making the film in multi-layer with different material having better toughness than PLA such as polyolefins (e.g., JP2008094365A).

(i) and (iii) could provide a film with improved toughness; however, with (i), the improvement in toughness is limited and not sufficient for use in shrink sleeve application, and the film obtained has reduced clarity. (iii) can provide a tough film; however, it would also make a film hazy. Further, (iii) requires a certain ratio of polyolefin layer in the total thickness of the film. The ratio of materials in a film from renewable resources is significantly lower than a film made mostly from PLA or other biodegradable or compostable materials, and as polyolefin is neither biodegradable nor compostable, the label made from such a film would not be biodegradable or compostable under common conditions.

Efforts based on (ii) do not deliver satisfactory results for heat shrinkable film.

In addition to the desired features above, PLA heat shrinkable film should have sufficient shrinkage and shrink properties. If shrinkage is too low, a label would not completely fit the container and leave unfinished area on the container, which requires high shrinkage. If shrink properties are not optimized, it would be difficult to control shrinkage, and a label may get wrinkles or would not give an expected result of finishing such as the label's top or bottom position on a container.

It is common in shrink sleeve label applications to seek shrinkage of 50% or more. For practical reasons, it is desirable for a heat shrinkable film to have 40-50% shrinkage at 80° C. If the shrinkage at 80° C. is less than 30%, the label would require additional heating or longer residence time or slower line speed at the shrinking process, which translates to lower efficiency and higher energy consumption. In some cases, even higher shrinkage is desired, and if the skrinkage at 100° C. is too low, the label may have difficulty tightly fitting over a narrow area of a container.

Shrink properties are generally represented by a “shrink curve,” which is a chart plotting the film's shrinkage at different temperatures. If the shrinkage increases too quickly in a certain narrow temperature range, it makes controlling the shrinkage difficult and may cause finishing problems mentioned above. If the shrinkage starts from too a low temperature, that means that the film is too sensitive to heat and would require special temperature control for storage, transportation, and processing environments. Consequently, it is desirable for a heat shrinkable film (i) not to shrink more than 5% when it is stored under the temperature of 40° C. and (ii) to have a shrink curve that increases the shrinkage gradually as the temperature increases from 60° C. to 100° C.

Thus, there is a need in the art for a heat shrinkable film that contains considerable amount of raw materials that are biodegradable and/or compostable, but also has a combination of desirable properties such as high impact strength, high elongation, and high clarity along with suitable shrinkage for use as a heat shrinkable sleeve label.

The present invention addresses this need as well as others that will become apparent from the following description and claims.

### SUMMARY OF THE INVENTION

In one preferred embodiment, the present invention provides a heat shrinkable film, which comprises:

(a) at least 60 weight percent of a poly(lactic acid); and

(b) at least 85 weight percent of biodegradable and/or compostable material, wherein the film has

(i) a haze value of 5% or less when measured at a film thickness of 50 microns according to ASTM D1003;

(ii) an elongation at break of 300% or greater in a direction perpendicular to the main shrinkage direction when measured at a film thickness of 50 microns according to ASTM D882; and

(iii) a rate of brittle failure of 50% or less when 10 samples of the film at a film thickness of 50 microns are consecutively tested according to ASTM D3420.

In another preferred embodiment, the present invention provides a heat shrinkable film wherein the film has a heat shrink curve R² value of 0.8 or greater when the percentage of film shrinkage in the main shrinkage direction is plotted versus temperature from the temperature at which shrinkage is greater than 5% to 100° C.

### BRIEF DESCRIPTION OF THE DRAWINGS

FIG. 1 shows the heat shrinkage curve of a PLA heat shrinkable film from US 2007/0116909.

FIG. 2 shows the heat shrinkage curve of a PLA heat shrinkable film sold by Plastic Suppliers, Inc.

FIG. 3 shows the heat shrinkage curve of the PLA heat shrinkable film from Example 1.

FIG. 4 shows the heat shrinkage curve of the PLA heat shrinkable film from Example 2.

FIG. 5 shows a film with brittle failure.

FIG. 6 shows a film with ductile failure.

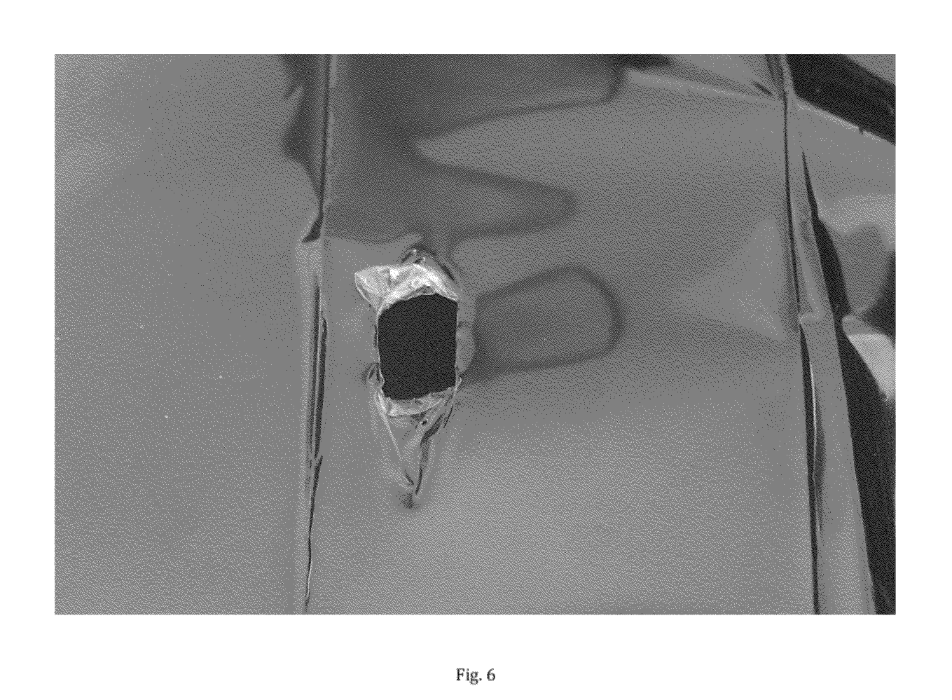

### DETAILED DESCRIPTION OF THE INVENTION

The heat shrinkable films of the invention are based on poly(lactic acid) (PLA). Various polymers and polymer grades of PLA are commercially available and may be used alone or as a blend in the films of the invention. For example, NatureWorks LLC offers different grades of PLA (e.g., grades 4043, 4060, 4042, and 4032) under the brand name Ingeo™. These PLAs are believed to have a weight-average molecular weight in the range of 200,000 to 400,000 and different percentages of D-lactide monomer. Any of these grades may be used, depending on the final properties desired, to make films in accordance with the invention.

The films of the invention preferably contain at least 60 weight percent of PLA. In some embodiments, the films may contain from 60 to 95 weight percent of PLA. In other embodiments, the films may contain from 70 to 90 weight percent of PLA. In yet other embodiments, the films may contain from 80 to 90 weight percent of PLA.

The films of the invention may contain one or more additives, such as silp/antiblocking agents, plasticizers, viscosity enhancers, impact modifiers, toughness enhancers, antioxidants, UV stabilizers, etc. Examples of antiblocking agents include silica, titania, zirconia, talc, calcium carbonate, and N,N′-ethylene bis(stearamide) (EBS). Examples of plasticizers include mono- and polycarboxylic acid esters, polymeric polyesters, polyalkyl ethers, glycerol and glycol esters (e.g., glycerol triacetate and glycerol tripropionate), low molecular weight aliphatic and aromatic polyesters, citrate esters, adipate, epoxidized soybean oils, acetylated coconut oil, linseed oil, and blends of thereof. Viscosity enhancers, impact modifiers, and toughness enhancers are generally known and are commercially available. Though the chemical identity of many additives is generally proprietary, the products are available from vendors such as Johnson Polymer LLC (USA), Clariant International Ltd. (Switzerland), Sukano Polymers Corp. (USA), and Unitika, Ltd. (Japan).

Some additives may also serve more than one function. For example, TERAMAC TP4000BSN, a proprietary additive from Unitika, offers both plasticizing and toughness enhancing ability. The use of such multifunctional additives is included within the scope of the invention.

The additives, depending on their character and function, may be present up to 40% by weight in the films of the invention. For example, the antiblocking agent may be used in amounts up to 3% by weight, more preferably, up to 2% by weight, based on the weight of the film. Moreover, other additives, such as the multifunctional additive like TERAMAC TP4000BSN, may be used in amounts ranging from 5 to 40% by weight, preferably from 10 to 30% by weight, and more preferably, from 10 to 20% by weight, based on the weight of the film.

Preferably, the additives would also be biodegradable and/or compostable, or at the very least, would not interfere with the PLA's ability to compost.

In some embodiments of the invention, the heat shrinkable film is composed of at least 85% by weight of biodegradable and/or compostable material (including the PLA). Preferably, the film contains at least 90% by weight of biodegradable and/or compostable material. More preferably, the film contains at least 93% by weight of biodegradable and/or compostable material.

In some embodiments of the invention, the heat shrinkable film has a haze value of 5% or less when measured at a film thickness of 50 microns according to ASTM D1003. Preferably, the film has a haze value of 4% or less.

In some embodiments of the invention, the heat shrinkable film has an elongation at break of 300% or greater in a direction perpendicular to the main shrinkage direction when measured at a film thickness of 50 microns according to ASTM D882. Preferably, the film has an elongation at break of 400% or greater, and more preferably, of 500% or greater.

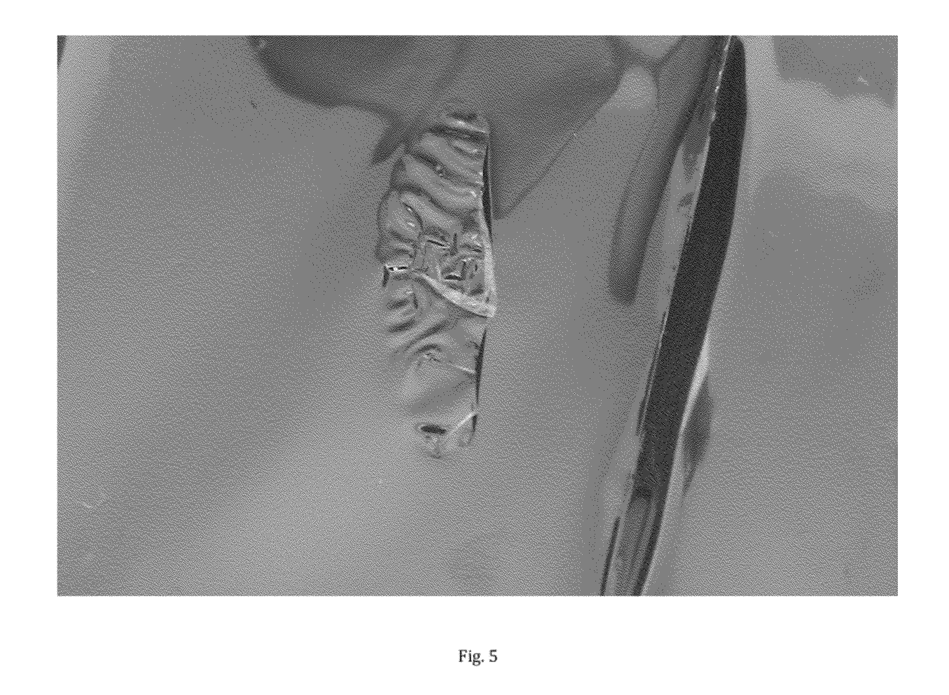

In some embodiments of the invention, the heat shrinkable film has a rate of brittle failure of 50% or less when 10 samples of the film at a film thickness of 50 microns are consecutively tested according to ASTM D3420. Brittle failure is the mode of failure that leaves a slit or a hole without a sign of film deformation before break. On the other hand, ductile failure leaves a hole with a sign of deformation before break. The typical examples of these failure modes are shown as FIGS. 5 (brittle failure) and 6 (ductile failure).

In some embodiments of the invention, the heat shrinkable film has a shrinkage in the main shrinkage direction of 50% or greater when exposed to 80° C. for 10 seconds according to ASTM D2732.

In some embodiments of the invention, when the percentage of film shrinkage in the main shrinkage direction is plotted on a graph versus temperature starting from the temperature at which the film shrinkage is greater than 5% all the way up to 100° C., the R² value of the resulting heat shrink curve is 0.8 or greater. R² is the square of the correlation coefficient. The correlation coefficient provides a measure of the reliability of the linear relationship between the temperature and the shrinkage percentage of the film. The closer the coefficient is to 1, the more reliable it is that the relationship is linear. Preferably, the film has a shrinkage curve R² value of 0.9 or greater.

The heat shrinkable films according to the invention may be prepared by methods known in the art. Generally, the PLA pellets and additives are dried to a moisture content of less than 500 ppm, preferably less than 200 ppm. The dried materials are then mixed and fed to an extruder where they are melted and extruded into sheets. The sheets are then rapidly cooled on a casting machine. The cooled sheets are then stretched in the transverse direction in a tenter box by a factor of 4.0-4.5 or more at a temperature in the range of 70-90° C. to obtained the final heat shrinkable film.

This invention can be further illustrated by the following examples of preferred embodiments thereof, although it will be understood that these examples are included merely for purposes of illustration and are not intended to limit the scope of the invention.

### EXAMPLES

### Examples 1-4

The raw materials in the proportions listed in Table 1 below were dried in a compound dryer to a moisture content of less than 200 ppm. The dried raw materials were then mixed and fed to an extruder and extruded through a T-die at 160-200° C. to obtain a sheet with a thickness of 235-270 microns. The extruded sheet was then rapidly cooled on a casting machine having a casting roll temperature of 20-30° C. The cooled sheet was stretched in the transverse direction in a tenter box to 4.5-4.9 times the original width at a hot air temperature of 75° C. The final stretched film had a thickness of 50 microns.

The stretched film was tested for tensile properties, haze, impact strength, and shrinkage. The results are shown in Table 2 below.

### Example 5

The raw materials in the proportions listed in Table 1 below were dried in a compound dryer to a moisture content of less than 200 ppm. The dried raw materials were then mixed and fed to an extruder and extruded through a T-die at 160-200° C. to obtain a sheet with a thickness of 235-270 microns. The extruded sheet was then rapidly cooled on a casting machine having a casting roll temperature of 20-30° C. The cooled sheet was stretched in the transverse direction in a tenter box to 4.5-4.9 times the original size at a hot air temperature of 82° C. The final stretched film had a thickness of 50 microns.

The stretched film was tested for tensile properties, haze, impact strength, and shrinkage. The results are shown in Table 2 below.

TABLE 1

| | NatureWorks ® PLA | | | | Additive (parts by weight) | | |
|---|---|---|---|---|---|---|---|
| Exam- | (parts by weight) | | | | TERAMAC | | |
| ple No. | 4043 | 4042 | 4032 | 4060 | TP4000BSN¹ | IM s555² | s511³ |
| 1 | 85 | | | | 15 | | 1 |
| 2 | 70 | | | | 30 | | 1 |
| 3 | 100 | | | | | | 1 |
| 4 | | 92 | | | | 8 | 1 |
| 5 | | | 30 | 70 | | | 1 |

¹Dual plasticizer and toughness enhancer obtained from Unitika.
²Impact modifier obtained from Sukano.
³Antiblock agent obtained from Sukano.

TABLE 2

| | Tensile Properties¹ | | | | | | | | |
|---|---|---|---|---|---|---|---|---|---|
| | Strength (psi) | | Elongation (%) | | Haze² | Impact | Shrinkage in TD⁴ (%) | | |
| | MD | TD | MD | TD | (%) | Strength³ | 70° C. | 80° C. | 100° C. |
| Example No. | | | | | | | | | |
| 1 | 9385 | 34622 | 543 | 38 | 1.9 | NF/D = | 43 | 53 | 80 |
| | | | | | | 50%/50% | | | |
| 2 | 9839 | 25715 | 506 | 32 | 2.7 | NF | 43 | 53 | 80 |
| 3 | 10006 | 40034 | 5 | 40 | 1 | 100% B | 43 | 53 | 80 |
| 4 | 7316 | — | 385 | — | 5 | 100% B | 73 | 76 | 77 |
| 5 | 10589 | 22110 | 4 | 84 | 1.8 | 100% B | 34 | 47 | 76 |
| Commercially | | | | | | | | | |
| Available | | | | | | | | | |
| Shrink Films | | | | | | | | | |
| Plastic | 9312 | — | 3~48 | — | — | 100% B | 57 | 72 | 78 |
| Supplier PLA | | | | | | | | | |

¹Determined according to ASTM D882.
²Determined according to ASTM D1003.
³Determined according to ASTM D3420. NF = non-failure (film did not form a hole or a slit); D = ductile failure (film formed a hole); and B = brittle failure (film formed a slit).
⁴Determined according to ASTM D2732 after 10 seconds of exposure.

### Example 6

The shrinkage of the films from Examples 1 and 2 as well as several other films listed in Table 3 was measured after exposure at 60, 70, 80, and 100° C. for 10 seconds according to ASTM D2732. The results are shown in Table 3 below.

TABLE 3

Shrinkage in TD (%)

| | 60° C. | 70° C. | 80° C. | 100° C. |
|---|---|---|---|---|
| US 2007/0116909¹ | 25 | 61 | 74 | 78 |
| Plastic Suppliers | 25 | 57 | 72 | 78 |
| PLA² | | | | |
| Example 1 | 2 | 43 | 53 | 80 |
| Example 2 | 2 | 43 | 53 | 80 |

¹The reported data was obtained from the document.
²This is a PLA shrink film offered by Plastic Suppliers.

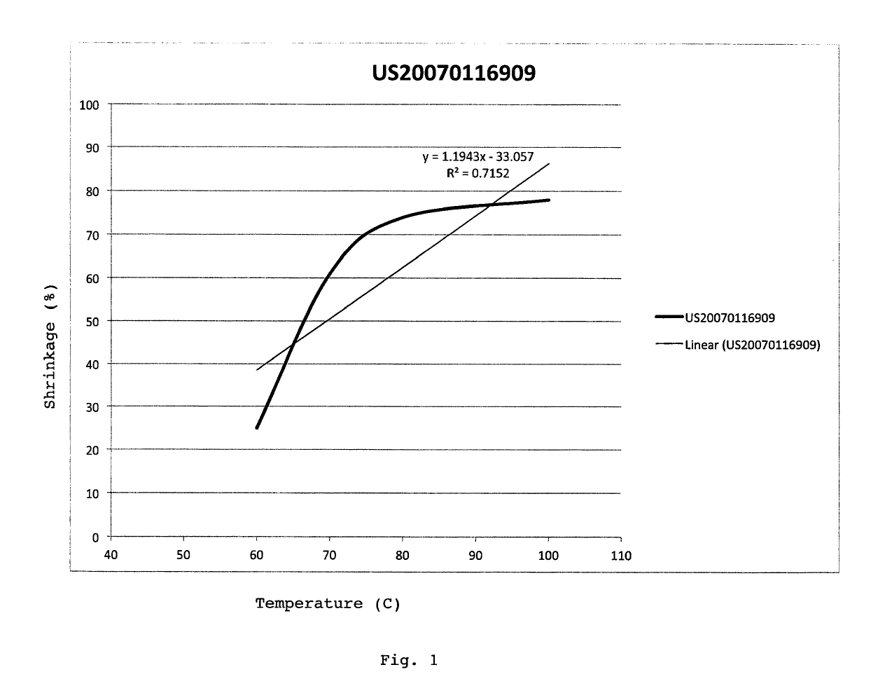

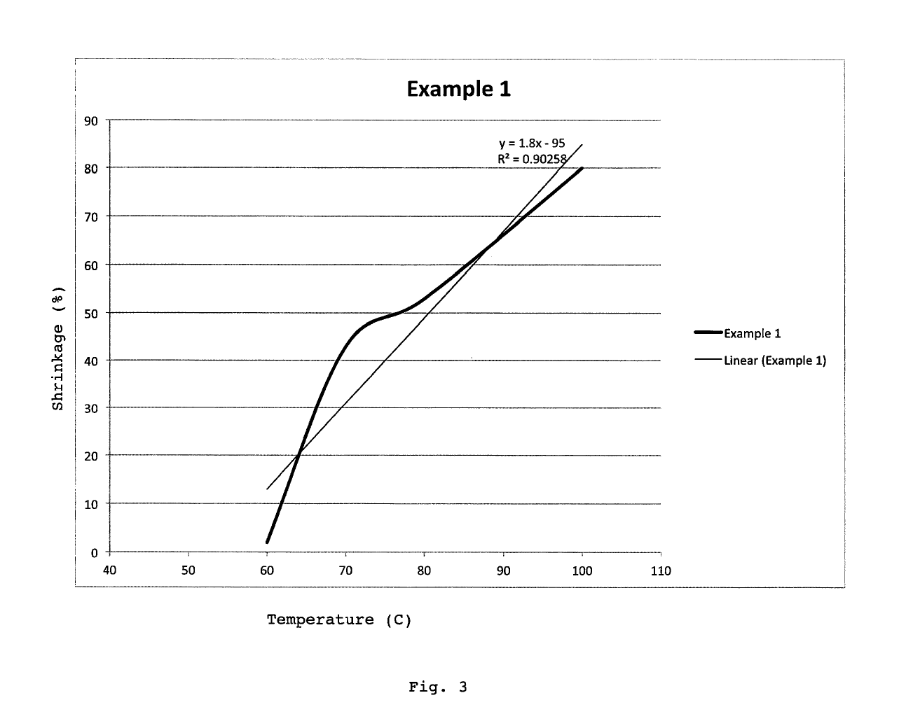

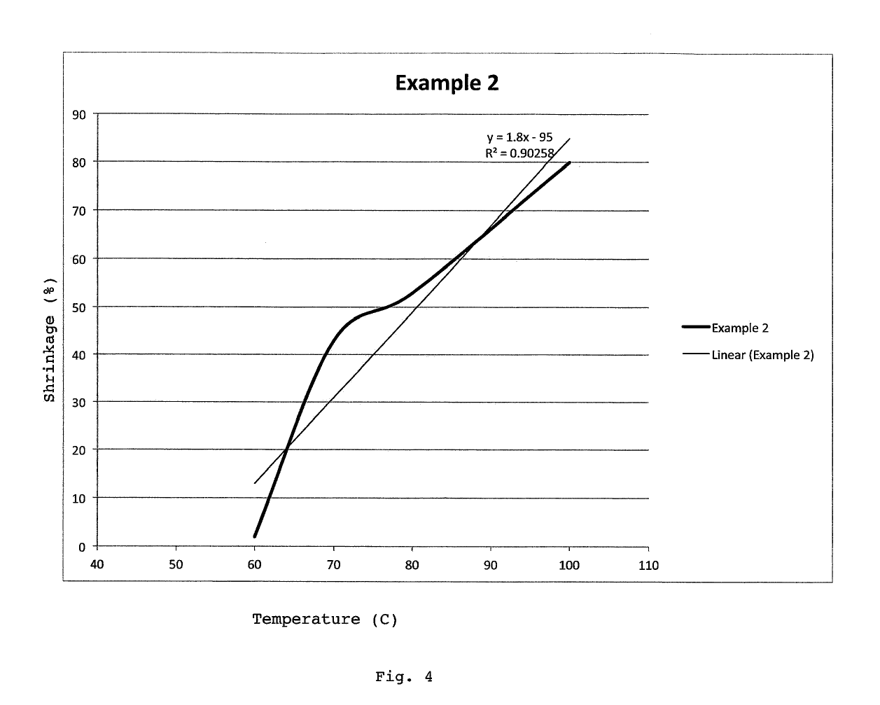

The shrinkage data in Table 3 was plotted in FIGS. 1-4, respectively. An approximation line was generated, and the slope and R² value of each set of data were calculated and displayed on the figures.

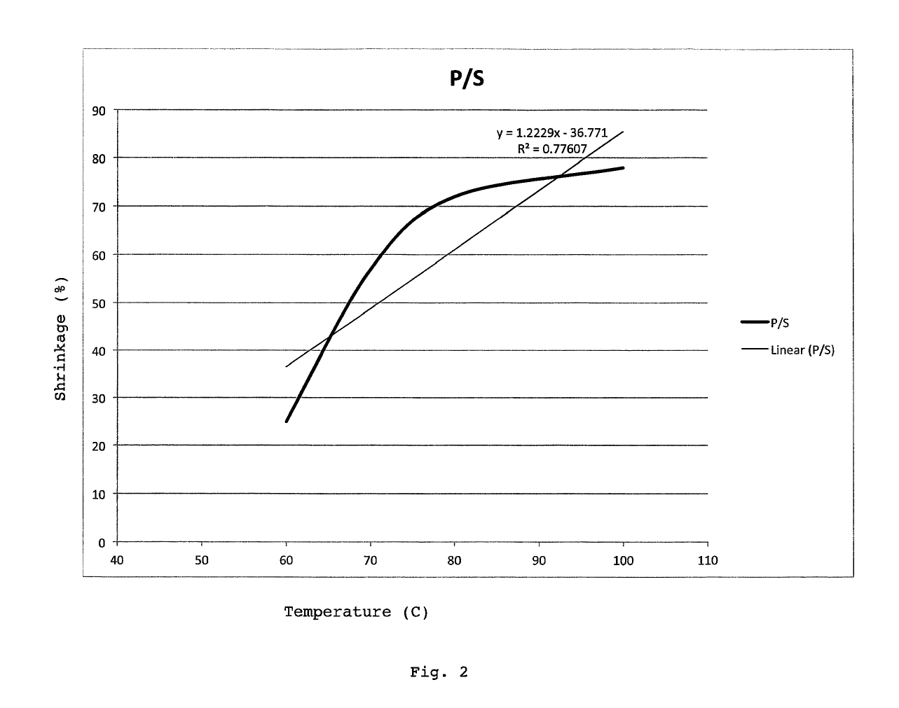

As seen from FIGS. 1 and 2, the R² values of these PLA shrink films are less than 0.8. In contrast, the R² values of the PLA shrink films in accordance with the invention in Examples 1 and 2 are greater than 0.9.

The invention has been described in detail with particular reference to preferred embodiments thereof, but it will be understood that variations and modifications can be effected within the spirit and scope of the invention.

We claim:

1. A heat shrinkable film comprising:
(a) at least 60 weight percent of a poly(lactic acid); and
(b) at least 85 weight percent of biodegradable and/or compostable material, wherein the film has
(i) a haze value of 5% or less when measured at a film thickness of 50 microns according to ASTM D1003,
(ii) an elongation at break of 300% or greater in a direction perpendicular to the main shrinkage direction when measured at a film thickness of 50 microns according to ASTM D882, and
(iii) a rate of brittle failure of 50% or less when 10 samples of the film at a film thickness of 50 microns are consecutively tested according to ASTM D3420.

2. The heat shrinkable film according to claim 1, wherein the haze value is 4% or less.

3. The heat shrinkable film according to claim 1, wherein the elongation at break is 400% or greater.

4. The heat shrinkable film according to claim 1, wherein the elongation at break is 500% or greater.

5. The heat shrinkable film according to claim 1, which has a shrinkage in the transverse direction of 50% or greater when exposed to 80° C. for 10 seconds according to ASTM D2732.

6. The heat shrinkable film according to claim 1, which has a heat shrink curve R² value of 0.8 or greater when the percentage of film shrinkage in the main shrinkage direction is plotted versus temperature from the temperature at which shrinkage is greater than 5% to 100° C.

7. The heat shrinkable film according to claim 1, which has a heat shrink curve R² value of 0.9 or greater when the percentage of film shrinkage in the main shrinkage direction is plotted versus temperature from the temperature at which shrinkage is greater than 5% to 100° C.

8. The heat shrinkable film according to claim 1, which comprises at least 90 weight percent of biodegradable and/or compostable material.

9. The heat shrinkable film according to claim 1, which comprises at least 93 weight percent of biodegradable and/or compostable material.

10. A label made from the heat shrinkable film according to claim 1.

11. A heat shrinkable film comprising:
(a) a poly(lactic acid); and
(b) a dual-purpose plasticizer and toughness enhancer additive,
wherein the film has a heat shrink curve R² value of 0.8 or greater when the percentage of film shrinkage in the main shrinkage direction is plotted versus temperature from the temperature at which shrinkage is greater than 5% to 100° C.

12. The heat shrinkable film according to claim 11, wherein the R² value is 0.9 or greater.

13. The heat shrinkable film according to claim 11, which comprises from 60 to 95 weight percent of the poly(lactic acid) and 5 to 40 weight percent of the dual-purpose plasticizer and toughness enhancer additive.

14. The heat shrinkable film according to claim 11, which comprises from 70 to 90 weight percent of the poly(lactic acid) and 10 to 30 weight percent of the dual-purpose plasticizer and toughness enhancer additive.

15. The heat shrinkable film according to claim 11, which comprises from 80 to 90 weight percent of the poly(lactic) acid and 10 to 20 weight percent of the dual-purpose plasticizer and toughness enhancer additive.

16. A label made from the heat shrinkable film according to claim 11.
